(19) United States
(12) Patent Application Publication
(10) Pub. No.: US 2009/0211421 A1
(43) Pub. Date: Aug. 27, 2009

(54) TEMPERATURE OR WEAR INDICATING DEVICE FOR MATERIAL-WORKING TOOLS

(75) Inventors: Andreas Lier, Hilzingen-Duchtlingen (DE); Achim Schneider, Radolfzel (DE); Andreas Frank, Hilzingen (DE); William J. Sullivan, Glenview, IL (US); Sailesh Athreya, Lake Villa, IL (US)

Correspondence Address: FLETCHER YODER (ILLINOIS TOOL WORKS INC.), P.O. BOX 692289, HOUSTON, TX, 77269-2289, US

(73) Assignee: Illinois Tool Works Inc., Glenview, IL (US)

(21) Appl. No.: 12/277,973

(22) Filed: Nov. 25, 2008

Related U.S. Application Data
(60) Provisional application No. 60/990,855, filed on Nov. 28, 2007.

(51) Int. Cl. B26D 7/27; G01N 3/56

(52) U.S. Cl. 83/522.27; 73/7

(57) ABSTRACT

Temperature or wear indicating device for material-working tools, in particular pipe-working tools, furthermore in particular saw blades, wherein the temperature or wear indicating device has at least one temperature or wear indicator, the temperature or wear indicator being at least partially produced from an indicator material that changes one of its visual properties, in particular its colour, permanently when a predetermined limit temperature is exceeded.

### CROSS REFERENCE TO RELATED APPLICATIONS

This application is a Non-provisional Patent Application of U.S. Provisional Patent Application No. 60/990,855, entitled “Thermo Chromic Ink-Based Wear Indicator for Saw Blades”, filed on Nov. 28, 2007, which is herein incorporated by reference.

### BACKGROUND

The present invention relates to a temperature or wear indicating device for material-working tools, also to the use of a material for producing a temperature or wear indicating device for material-working tools, and in particular to a material-working tool, preferably a saw blade, according to the patent claims.

In today's high-tech industrialized society, it is essential for materials to be worked as quickly as possible and at the lowest possible cost. At the same time, materials with extremely different properties (different degrees of hardness, different toughness, different density, etc.) have to be worked, i.e. the materials have for example to be separated or subjected to a specific desired shaping (as is the case for example when working metal in a machining operation). In particular in the case of material working performed with the aid of machines, a measurable amount of heat is often produced. For example, when sawing wood or metal and when working material by machining (for example turning or milling), heat is produced as a result of the friction occurring during the working.

It is generally true for material-working operations that the more heat that is produced, the greater the degree of abrasion or wear of the material-working tool. On workpieces, this may have the effect that undesired changes of the material properties, such as for example structural changes in the case of metals or colour changes of the surface in the case of wood, may occur during working, particularly in the regions that are worked or in neighbouring regions. These changes of the material properties often have the result that the piece of material that has been worked can no longer be used. Undesired, increased heat production along with an excessive degree of wear of material-working tools is generally counteracted by changing the tool at an early time, which however has the result that the tool is not optimally used and consequently increased production costs are incurred. As an alternative to this, corresponding quality control of the final product may also be carried out, which however is very cost-intensive, in particular in the case of control of a metallic material with respect to the condition of its microstructure.

### BRIEF DESCRIPTION

The present invention provides a temperature or wear indicating device for material-working tools and also a corresponding material-working tool that enable the user to be able to determine the degree of wear or abrasion of the material-working tool in a simple way.

The invention, in particular, provides a temperature or wear indicating device according to claim 1. The aspect of providing a corresponding material-working tool is achieved by a material-working tool with the features of claim 8.

Furthermore, the concept of the present invention includes using thermochromic materials suitable for producing temperature or wear indicating devices to produce the same.

### DRAWINGS

The invention is described by way of example below on the basis of preferred embodiments with reference to the accompanying drawings, in which:

FIG. 1 shows a typical temperature profile of a circular disc-shaped saw blade during a single cut;

FIG. 2 shows a typical temperature profile of the saw blade according to FIG. 1 during a multiplicity of cuts;

FIG. 3 shows a first embodiment of a material-working tool according to the invention in the form of a saw blade, with a first embodiment of a wear indicating device according to the invention;

FIG. 4 shows a cross section through part of the wear indicating device according to FIG. 3 along the axis A-A;

FIG. 5 shows a summary of the state of the wear indicating device according to FIGS. 3 and 4 after 8 to 151 cuts;

FIG. 6 shows a second possible embodiment of a material-working tool according to the invention, in turn in the form of a saw blade, with a second embodiment of a wear indicating device according to the invention;

FIG. 7 shows a section through the material-working tool according to FIG. 6 along the axis B-B; and

FIG. 8 shows a side view of a further embodiment of a circular saw blade according to the invention.

### DETAILED DESCRIPTION

Material-working tools may be inter alia saw blades, machining tools such as turning tools or milling cutters (milling heads) as well as other tools, such as for example drills, grinding wheels and the like. Temperature or wear indicating devices may be used together with all conceivable material-working tools familiar to a person skilled in the art, such as for example the material-working tools listed above. For the user of the material-working tool, it is important to know the current state of abrasion or wear. As a consequence, the temperature or wear indicating devices according to the invention and also the material-working tools according to the invention are to be explained on the basis of an example from metal working, to be specific on the basis of a saw blade 10 for working pipes. It goes without saying that this is merely by way of example and must not be interpreted in a restrictive way.

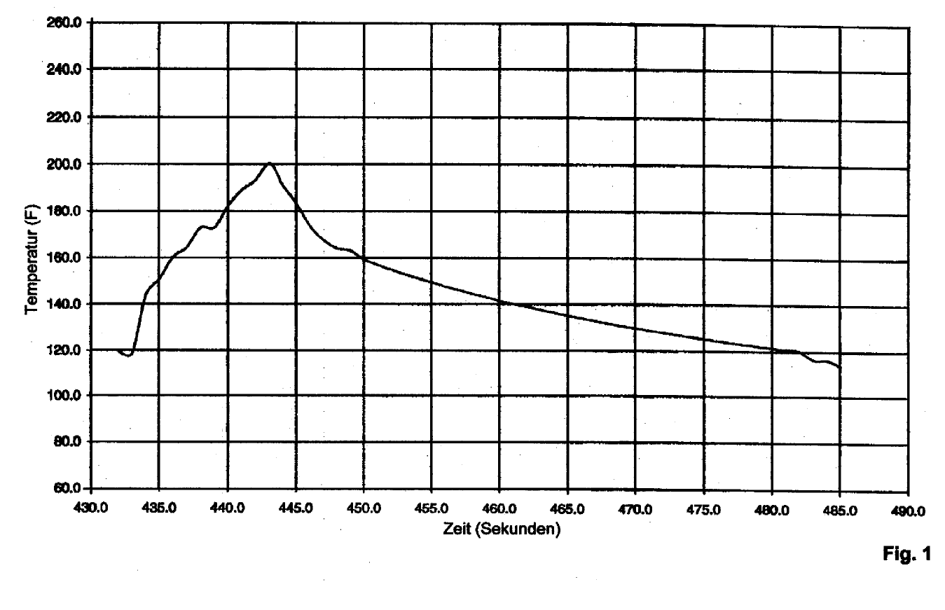

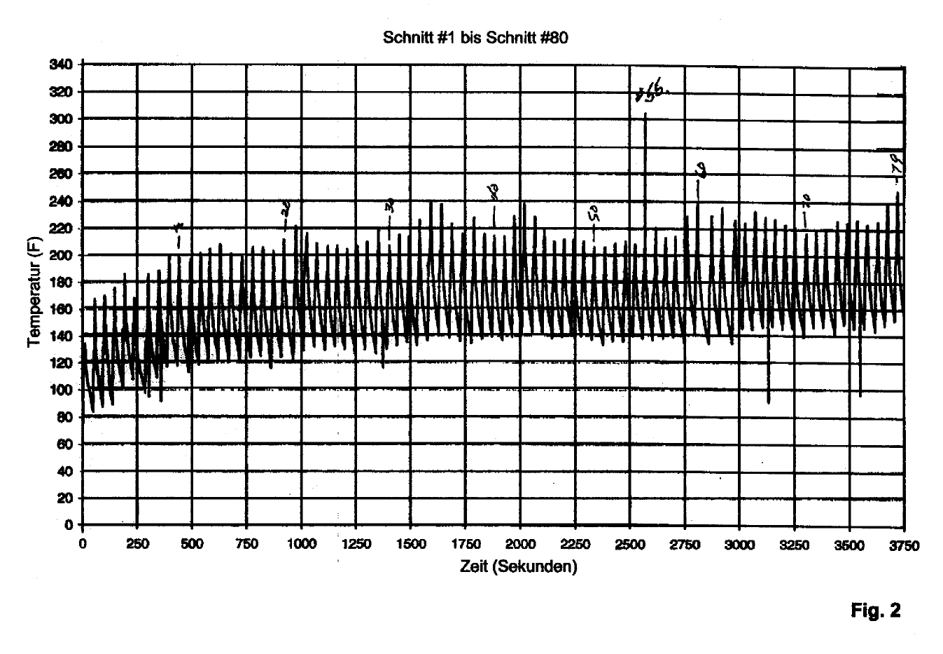

During a single step, each region of the saw blade 10 goes through a thermal cycle, as represented in FIG. 1. The temperature in the respective region thereby depends mainly on the radius at which the temperature is measured. The material of the pipe to be cut, the wall thickness of the pipe and the state of the saw blade (the degree of wear of the saw blade) are also important. In FIG. 2, the temperature profile is in turn represented for a saw blade, but this time for a multiplicity of cuts, it being possible to see that the temperature of the saw blade increases as the number of cuts increases.

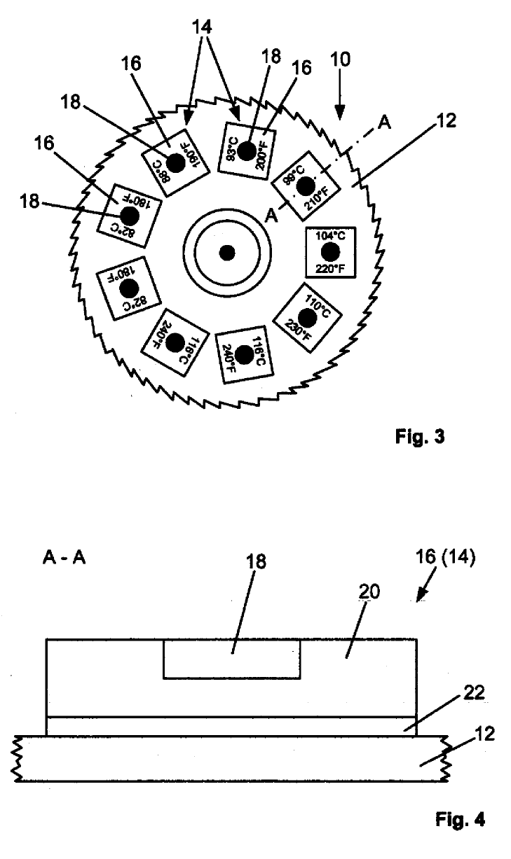

The circular disc-shaped saw blade 10 itself is represented in FIG. 3. It comprises a cutting body 12, which is a disc produced from steel with a serration on its outer circumferential edge for cutting a pipe to be cut, and also a temperature or wear indicating device 14. The temperature or wear indicating device 14 has one or more, for example nine, wear indicating sub-devices or temperature indicating sub-devices 16, which are respectively arranged on at least one side face of the cutting body 10. The wear indicating sub-devices 16 in each case have a visual wear indicator 18 in their centre, which is formed for example in a circular manner. Furthermore, they have a temperature or wear indicator carrier 20, on which the temperature or wear indicating device 18 is arranged. The temperature or wear indicator carrier 20 may surround the temperature or wear indicator 18 (cf. also FIG. 4 in this respect). The temperature or wear indicators 18 comprise a thermochromic indicator material or consist of such an indicator material, which changes its colour permanently when a predetermined limit temperature is exceeded. In the embodiment described, the thermochromic indicator material changes its colour from white to black.

The indicating device 14, indicating sub-devices 16 and indicators 18 may be formed in such a way that, when there is a temperature-dependent colour change, the user detects that the saw blade is worn and therefore has to be changed, or be formed in such a way that, when there is a temperature-dependent colour change, the user detects that he must interrupt the cutting operation, because otherwise a temperature that is harmful to the material, in particular the cutting elements, of the saw blade (or of the pipe worked) would occur.

In the first embodiment described, the temperature or wear indicator carrier 20 is produced from a suitable plastic. The indicator material is sprayed or poured into a depression arranged on the temperature or wear indicator carrier 20. For this purpose, the indicator material is sprayable or liquid. In particular, thermochromic inks or emulsions or suspensions with thermochromic materials are suitable for this. It goes without saying that, as an alternative to this, appropriately shaped solid indicator materials may also be fastened on the temperature or wear indicator carrier 20, possibly by a suitable fastening means (for example adhesive).

The temperature or wear indicator carrier 20 may itself adhere directly to the cutting body or be provided with a fastening means in the form of an adhesive layer 22, by means of which the respective wear indicating sub-device or temperature-indicating sub-device 16 can be fastened to the cutting body 12. It should be mentioned at this point that it goes without saying that the wear indicating sub-devices or temperature indicating sub-devices 16 may also be arranged on a single carrier 20, it being possible in turn for said carrier itself to have a fastening means on its side facing the cutting body 12, for fastening to the cutting body 12. Alternatively, the temperature or wear indicator carrier 20 may be formed in such a way that it can receive a number of temperature or wear indicators 18. For circular material-working tools (for example saw blade 10), the temperature or wear indicator carrier 20 may, for example, be formed in an annular manner, since the temperature of the material-working tool is also dependent on the radius (the distance from the sawing teeth) and it is consequently recommendable to arrange all the temperature or wear indicators 18 on one and the same podium.

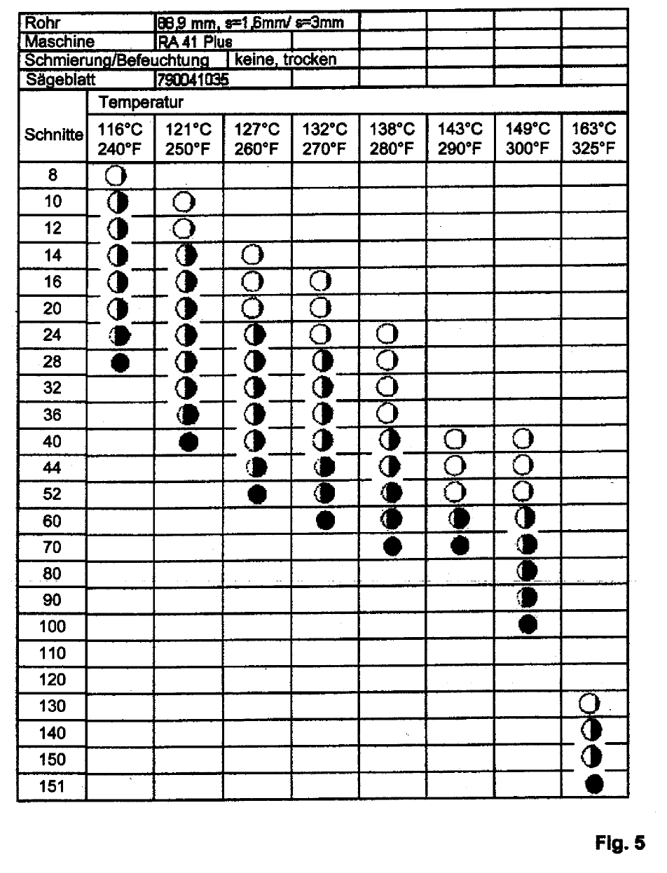

In FIG. 5, the colour change of the temperature or wear indicators 18 of the individual wear indicating sub-devices or temperature indicating sub-devices 16 is shown in dependence on the number of cuts carried out and in dependence on the respective limit temperature applicable to the temperature or wear indicators 18. As can be seen from the diagram, for example, the temperature or wear indicator 18 for 160° C. is coloured completely black after 28 cuts, while the temperature or wear indicator 18 with a limit temperature of 149° C. is only coloured completely after 100 cuts. The colouring begins from eight cuts in the case of the 160° C. indicator, from forty cuts in the case of the 149° C. indicator. By observing the degree of colouring of the temperature or wear indicators 18 of the individual wear indicating sub-devices or temperature indicating sub-devices 16, it is possible for the user to estimate the end of the lifetime of the saw blade 10.

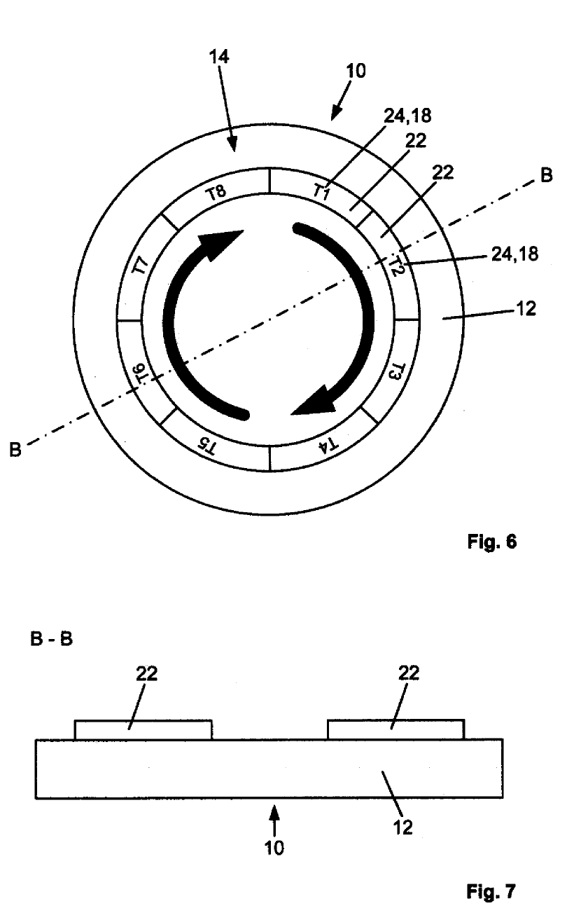

In FIG. 6, a second embodiment of a material-working tool according to the invention is represented, in turn in the form of a saw blade 10 (the serration on the outer circumferential edge is not represented), which has a wear indicating device 14, which is formed in an annular manner and has a number of sectors 22 with in each case a wear indicating sub-device or temperature indicating sub-device 24. In the embodiment described, the sectors 22 correspond to the wear indicating sub-device or temperature indicating sub-device 24, it alternatively being conceivable for the wear indicating sub-device or temperature indicating sub-device 24 to extend only over some of the sectors 22. Each sector 22 or each wear indicating sub-device or temperature indicating sub-device 24 comprises as a wear indicator 16 an indicator material in the form of a thermochromic ink, different limit temperatures applying to the different sectors 22, so that in turn the state of temperature or wear of the saw blade 10 can be estimated. During production, the saw blade 10 is printed with the thermochromic inks, which form the temperature or wear indicating device 14 after drying. In the embodiment described, the limit temperature of sector 8 is higher than that of sector 7, which in turn is higher than that of sector 6, etc. The saw blade 10 according to FIG. 6 is shown once again in section in FIG. 7.

As already mentioned above, the concept of the present invention also includes the use of a material or indicator material that changes one of its visual properties, in the embodiment described its colour, when a predetermined limit temperature is exceeded for producing a temperature or wear indicating device for material-working tools, in particular pipe-working tools and in particular saw blades.

To sum up, it can be stated that the present invention relates inter alia to the use of thermochromic inks or labels on a saw blade 10, in order in this way to help to predict the end of the useful life of a saw blade. The present invention relates inter alia to a design feature in the saw blade 10 that indicates the remaining useful life of the saw blade 10.

Saw blades 10 for cutting a pipe are chosen both on the basis of the steel to be cut and on the basis of the wall thickness of the pipe. As soon as these saw blades 10 are fastened to the machine, the machine is used for cutting pipes, on the basis of the needs at the workplace.

On the basis of the chosen saw blade 10 and the pipe to be cut, it is possible to carry out from 30 cuts to 160 cuts or more. The only way in which the user of a pipe saw knows when a saw blade 10 is worn is if the saw blade 10 induces a great torque and jams. If a worn saw blade 10 is used for cutting, the saw blade 10 can become red hot and may sometimes break up.

The disclosed concept helps to predict the end of the useful life of the saw blade without the risk of damaging the pipe or the risk of injury to an operator. This disclosure relates to the application or printing of a marking on the saw blade 10, the marking comprising at least one thermochromic ink or some other thermochromic dye, which reacts to specific temperatures. During a single cut, each point on the saw blade passes through a thermal cycle, similar to that represented in FIG. 1. The level of the temperature depends on the radius at which the temperature is measured, the pipe material, the wall thickness and the state of the saw blade 10 (or how worn the saw blade 10 is).

Strategically chosen inks or dyes placed at this point react to this temperature and change their colour. In the case of a number of cuts, the marking reacts completely and the colour change is complete. An ink or dye intended for low temperatures changes colour after a few cycles, by contrast with an ink or dye intended for higher temperatures, which needs much longer (or more cycles). If an ink intended for a specific limit temperature or some other dye intended for a specific limit temperature is chosen and applied to a correctly chosen point, the complete colour change can be associated with the useful life of the cutter.

The following was found in tests:

Thermally reactive labels, classified for a temperature in the range from 82.2° C. to 162.8° C. (180 F to 325 F), were applied in a circular manner to a saw blade 10 (in a way similar to in FIG. 3). These stickers have a white colour. If they are exposed to the specific temperatures for which they are designed, they change their colour to black. After applying these stickers, we began cutting off thin slices from a typical pipe. For this cutting test, a pipe with a diameter of 88.9 mm and a wall thickness of 1.6 mm was used. The state of the colour change of the various stickers was observed during this test. The colour of the stickers after different cuts is represented in FIG. 5. It was found that the sticker classified for 162.8° C. (325 F) became completely black after 150 cuts, approximately at the end of the lifetime of the saw blade 10.

This test showed that, if a correctly classified thermochromic ink is chosen and used for marking specific points on the blade surface, its colour change can approximately represent the end of the useful life of the saw blade 10. If these markings are also provided in a sectored, annular pattern (see FIG. 6), so that the annular portions comprise inks which are classified according to increasing temperatures, a better progressive indication of the remaining useful life is obtained for the user. If they have been correctly chosen, the sector with T1 changes colour after ⅛ of the useful life, T2 after ¼ of the useful life, and so on, with the colour change of T8 corresponding to the end of the useful life of the saw blade.

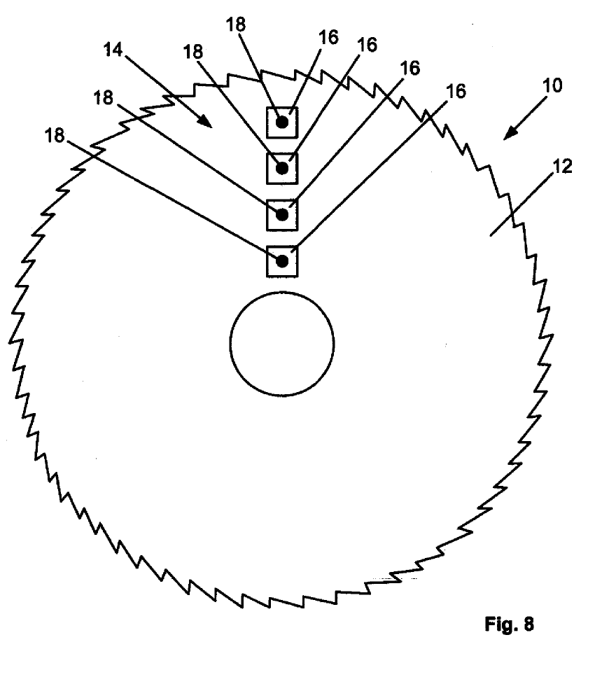

FIG. 8 of the drawings shows a further embodiment of a circular disc-shaped saw blade 10 according to the invention, in which at least two or more, for example four, temperature or wear indicating devices 14, with in each case at least one temperature or wear indicator 18, are arranged at different radial positions, for example one over the other along a radial line, on one or both sides of its cutting body 12. In the way described, the temperature or wear indicator 18 is or comprises in each case a thermochromic indicator material, which changes its shape and/or its colour, depending on the embodiment, when a predetermined limit temperature is exceeded.

The invention has the advantage that the colour change when the limit temperature is exceeded can indicate to the user of the saw blade 10 that the saw blade 10 has become blunt and therefore must be re-ground or replaced. However, the invention also has another possible application, to be specific the avoidance of material-damaging high temperatures in the saw blade 10 and/or in the workpiece to be sawn, for example a pipe, which may both consist of metal. This further application of the invention includes the concept of using for the at least one temperature or wear indicator 18 a thermochromic indicator material which changes its colour when a predetermined limit temperature is exceeded, said temperature being chosen at such a low level that it indicates to the user that the sawing operation should be interrupted, because otherwise, if the limit temperature is exceeded further, the material of the saw blade 10, or in another application the material of the workpiece, for example the pipe, would be adversely influenced. The material of the cutting body 12 of the saw blade 10, in particular the material of cutting elements on teeth of the saw blade 10, and/or the material of the pipe may specifically be high-alloyed steel, which is changed in its microstructure at particularly high temperatures. Furthermore, there is the risk that, under improper high temperatures, constituents of the material, for example chromium, can escape from the material. This depletion of the material of chromium, has the effect for example that stainless high-grade steel will rust.

Accordingly, a saw blade may have at least one wear indicator 18 designed for one purpose and/or at least one wear indicator 18 designed for another purpose.

Although the invention has been described on the basis of embodiments with set, defined combinations of features, it also comprises other conceivable combinations. All the features disclosed in the application documents are claimed as an invention in so far as they are novel over the prior art individually or in combination.

1. Temperature or wear indicating device for material-working tools, in particular pipe-working tools, furthermore in particular saw blades, wherein the temperature or wear indicating device has at least one temperature or wear indicator, the temperature or wear indicator being at least partially produced from an indicator material that changes one of its visual properties, in particular its colour, permanently when a predetermined limit temperature is exceeded.

2. A device according to claim 1, wherein the temperature or wear indicating device at least partially comprises an indicator material layer applied to the material-working tool or an indicator material layer applied to a carrier.

3. A device according to claim 1, wherein the indicator material is sprayable.

4. A device according to claim 1, wherein the temperature or wear indicating device is at least partially provided with a fastening means.

5. A device according to claim 1, wherein the temperature or wear indicating device is at least partially produced from two or more indicator materials which in each case permanently change one of their visual properties when a predetermined limit temperature is exceeded, the limit temperatures of the two or more indicator materials being different.

6. A device according to claim 1, wherein the temperature or wear indicating device is formed in an annular manner and is divided up into a number of sectors, each sector respectively having at least one temperature or wear indicating sub-device with in each case a temperature or wear indicator, at least two sectors or at least two temperature or wear indicators being at least partially produced from different indicator materials with in each case a different limit temperature.

7. A method for producing a temperature or wear indicating device for material-working tools, in particular pipe-working tools, furthermore in particular saw blades, comprising disposing an indicating device on the tool made of a material that changes one of its visual properties, in particular its colour, when a predetermined limit temperature is exceeded for producing.

8. Material-working tool, in particular a pipe-working tool, furthermore in particular a saw blade, wherein the material-working tool has a temperature or wear indicating device according to one of claim 1.

9. Material-working tool, in particular a pipe-working tool, furthermore in particular a saw blade, according to claim 8, at least two temperature or wear indicators are arranged at various radial positions with respect to a centre of rotation of the material-working tool.
